(19) United States
(12) Patent Application Publication
(10) Pub. No.: US 2003/0227736 A1
(43) Pub. Date: Dec. 11, 2003

(54) Safety switch with unlatching disc

(76) Inventor: Erik Baechle, Filderstadt (DE)

Correspondence Address: Mark S Bicks, Roylance Abrams Berdo & Goodman, Suite 600, 1300 19th Street N W, Washington, DC, 20036, US

(21) Appl. No.: 10/415,475

(22) PCT Filed: Feb. 8, 2002
(86) PCT No.: PCT/EP02/01334

(30) Foreign Application Priority Data
Feb. 10, 2001 (DE) 10106228.1

(51) Int. Cl. H01H 47/00

(52) U.S. Cl. 361/160

(57) ABSTRACT

The invention relates to a device with which an electrical connection is switched in accordance with the condition of a device to be monitored, especially to a safety switch (1) for a protective device. Said safety switch comprises a housing (2, 3) in which a switch disc (7) is mounted to be rotatable about an axis (8) and into which an actuator (5) for triggering the switching process can be inserted. The switch further comprises a latching device for blocking the switch disc (7), said latching device having a latching element (12a, 12b) which is guided in the switch disc (7) and movable against the effect of a first energy accumulator (11). In a position in which it blocks the switch disc (7) the latching element (12a, 12b) engages with an associated recess (13a, 13b) in the housing (2, 3). The inventive switch is further characterized in that the latching device comprises a rotatable unlatching element (14a, 14b) disposed beside the switch disc (7), which can be rotated relative to the switch disc (7) when the actuator (5) is inserted. When the unlatching element (14a, 14b) is rotated, the latching element (12a, 12B) is slid back parallel to the axis (8) into the switch disc (7) against the effect of the first energy accumulator (11), thereby placing it in the deblocking position.

This invention relates to a device for switching an electric connection as a function of the state of an appliance to be monitored, in particular a safety switch for a protective appliance.

Generic safety switches for safety appliances to be monitored, such as ones on production equipment, are disclosed in DE 43 28 296 C1.

Safety switches with a housing in which a switching disk is rotatably mounted around a shaft and into with an actuator initiating the switching process may be introduced, and with a locking mechanism for blocking the switching disk are disclosed in EP 0 778 595 A1, which corresponds to U.S. Pat. No. 5,898,143. The locking mechanism has, in the safety switch illustrated in this patent, a locking element which may be moved against the force of an energy accumulator, it being possible to move the locking element, which in a position blocking the switching disk may be moved into engagement with a groove on the circumferential surface of the switching disk. The locking element is contained in the housing in the process. Engagement with the switching disk takes place in a radial direction relative to the axis of rotation. In the event of strong force application the danger exists that the circumferential surface of the switching disk may be damaged by the locking element.

JP 8-203 389 A discloses a safety switch in which a locking element pivotably mounted in the housing is engaged in a groove in the switching disk in the radial direction and thereby blocks the rotary movement of the switching disk.

JP 7-260 089 A discloses a safety switch in which an elongated locking rod may be moved radially relative to the axis of rotation of the switching disk, thereby releasing the rotary movement of the switching disk when the actuator is introduced.

DE 43 38 910 C1 discloses a safety switch in which an integral release and locking element may be moved radially relative to the switching disk when the actuator is introduced, thereby freeing the rotary movement of the switching disk.

DE 36 09 043 C2 discloses a safety switch having the features specified in the preamble of claim 1, and a locking mechanism in particular, such safety switch having a locking element contained in the switching disk and acting against the action of an energy accumulator, such locking element is engaged in an associated recess in the housing in a position blocking the switching disk. One disadvantage is that the locking element is moved directly by the actuator to be introduced, something which diminishes the reliability of handling.

The invention has the object of providing a safety switch which ensures long-term handling reliability. In addition, the object is pursued of making certain that the safety switch and the associated actuator may be cost effectively produced.

It is claimed for the invention that this object is attained in that the locking mechanism has a rotary release element mounted next to the switching disk, which release element may be rotated relative to the switching disk and in the process transfers the locking element to a releasing position. Special embodiments of the invention are disclosed in the dependent claims.

It is claimed for the invention that the locking element is movable parallel to the axis of the switching disk and displaces the release element backward into the switching disk on release of the locking element against the action of the first energy accumulator.

In addition, the axis of rotation of the release element by preference coincides with the axis of the switching disk. The release element may have flanks projecting from the switching disk, ones which act in conjunction with a corresponding crosspiece of the actuator extending in general transversely to the direction of introduction, and/or the crosspiece of the actuator may be U-shaped, for example, so that, in a first segment of movement during introduction, it rotates the release element only and, in an immediately following second segment of movement also engages and rotates the switching disk.

The release element in this instance preferably may be rotated relative to the switching roller against the action of a second energy accumulator. The second energy accumulator may, for example, be in the form of a torsion spring, a so-called leg spring the first leg of which rests against the switching disk and the second leg of which rests against the release element.

In one particular embodiment the release element has an opening for axial passage of the latching element, the opening extending around the axis of rotation approximately in the shape of an arc and having at least two areas the edges of which acting in conjunction with the latching element are spaced different radial distances from the axis of rotation. The opening is preferably offset back from the radial end of the release element and itself may have an open or closed edge. The opening preferably has two associated areas with openings of different sizes, a first area having a width large enough for the latching element in the recess in the housing blocking the switching disk.

The latching element and/or the release element have/has a diagonal surface by which the rotary movement of the latching element may be reoriented to axial movement of the latching element. For this purpose, for example, the latching element may have a tapering section for operation in conjunction with the release element, so that the angle enclosed by the tapering section and the longitudinal axis of the latching element and/or the length of the tapering section, for example, may be adapted to the respective application.

The release element is preferably more or less in the form of a disk. In addition, the axis of rotation of the release element is mounted so as to be transverse to the direction of insertion of the actuator.

In one particular embodiment a release element is mounted on both sides of the switching disk, and each of the release elements operates in conjunction with at least one latching element. The latching elements associated with each other on opposite sides of the switching disk preferably have a common first energy accumulator.

In one particular embodiment the device has a switching rod on which are mounted electric contact elements guided axially in the housing and kept in contact with a circumferential surface of the switching disk. The outline of the circumferential surface determines the switching path of the switching rod. The axis of the switching disk and preferably the axis of rotation of the release element are mounted transversely to the longitudinal axis of the switching rod.

Other advantages, features, and details of the invention are specified in the dependent claims and in the following description, in which an exemplary embodiment is described in detail with reference to the drawings, The features mentioned in the claims and in the description may be essential to the invention either individually or in any combination.

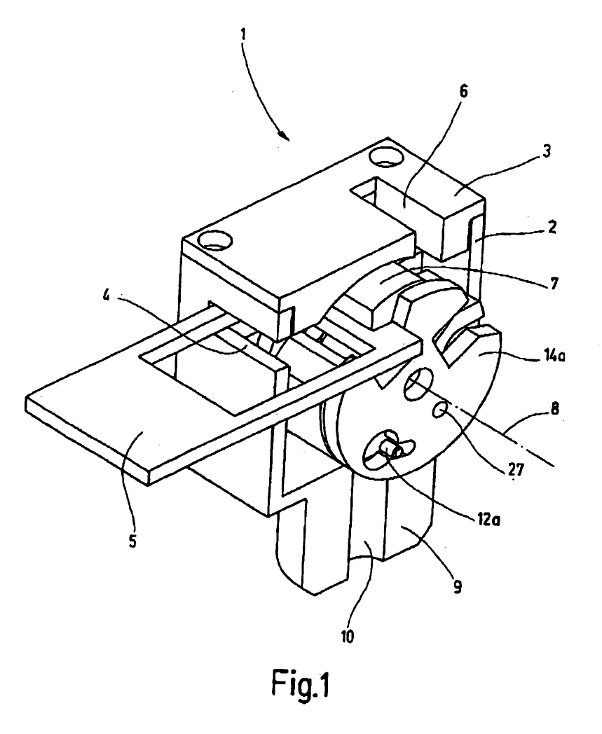

FIG. 1 illustrates a safety switch claimed for the invention,

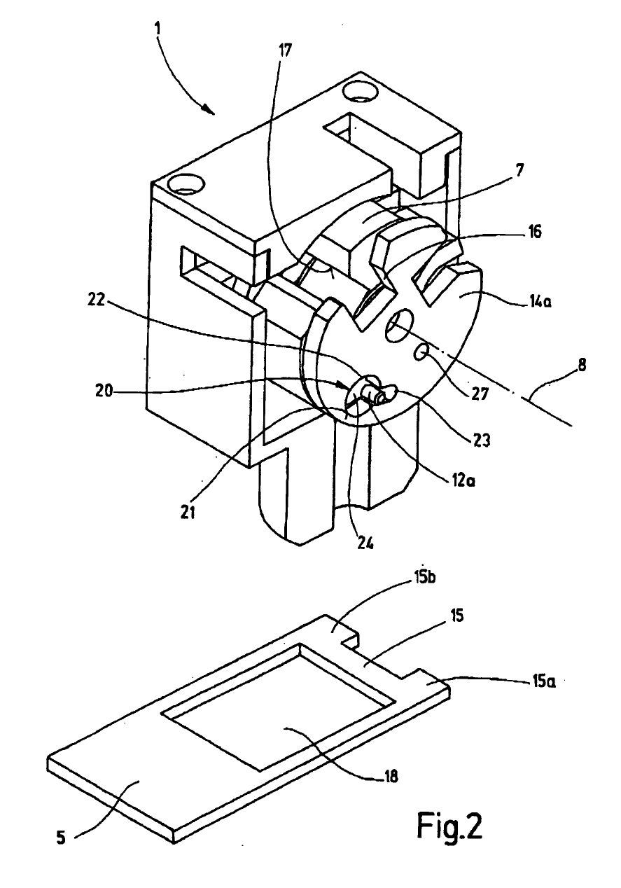

FIG. 2 the safety switch, the actuator being shown separately,

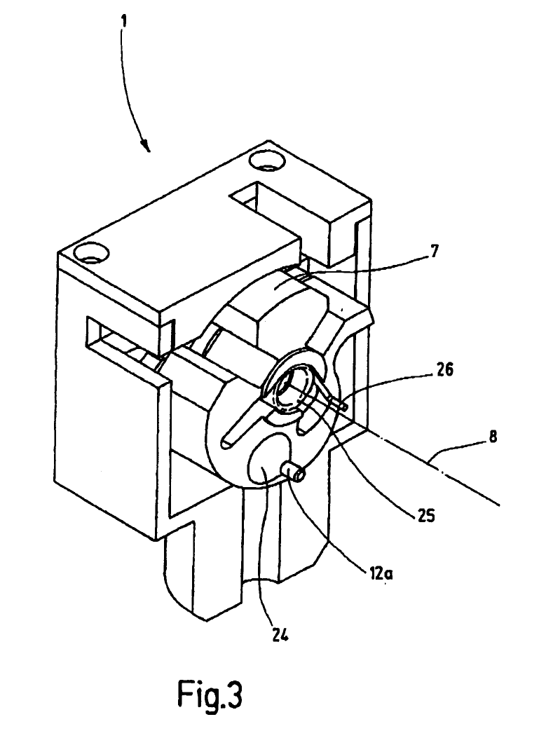

FIG. 3 the safety switch with the release element removed, and

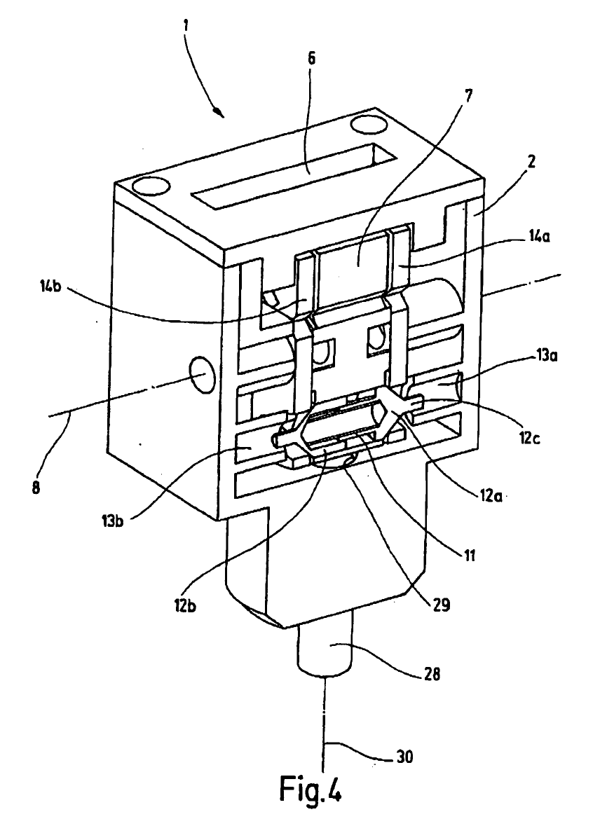

FIG. 4 a perspective view of a section through the safety switch.

FIG. 1 presents a safety switch 1 as claimed for the invention, with a housing having a housing top part 2 and a housing cover 3 which may be slip-on mounted on the housing top part 2 and fastened to it, for example by screws. The housing top part 2 has a first insertion slot 4 for the actuator 5. The housing cover 3 has a second insertion slot 6 for the actuator 5. The directions of insertion predetermined by the two insertion slots 4, 6 enclose an angle of more or less 90°.

A switching disk 7 is mounted in the housing top part 2 so as to be rotatable about an axis 8. When the actuator 5 is inserted into at least one of the two insertion slots 4, 6 the switching disk 7 illustrated in FIG. 1 is rotated clockwise and as a result a switching rod 28 (not shown in FIG. 1) is displaced axially so that an electric connection is made. The guide of the switching rod 28 and the electric contact elements are mounted in a switch housing component not shown in FIG. 1 of the safety switch 1 attached to the socket 9 integral with the housing top 2. The switching rod 28 is in any event guided among other components also by the cylindrical bore 10 of the socket 9.

The safety switch 1 has a latching mechanism to block the switching disk 7, which latching mechanism has a latching element 12a which is guided in the switching disk 7 and is movable against the action of a first energy accumulator 11; in a position blocking the switching disk 7 this latching element 12a is engaged in an associated recess 13a in the housing top part 2. For the purpose of release the latching mechanism has a rotatable release element 14a which is rotatable relative to the switching disk 7 when the actuator 5 is inserted and transfers the latching element 12a to an unblocking position, and in particular forces it back into the switching disk 7 against the action of a first energy accumulator 11. The unblocking position of the latching element 12a is illustrated in FIG. 1.

FIG. 2 presents the safety switch 1 in the same configuration as in FIG. 1, but here with the actuator 5 shown separately, the unblocking position of the latching element 12a of FIG. 1 being retained, with the result that the release element 14a has been rotated clockwise by an angular amount of approximately 15° relative to the switching disk 7, for example, from the initial position blocking the switching disk 7. This is achieved in that the actuator 5 has on its end facing the switching disk 7 a U-shaped crossbar 15 which has on each of its two ends a projection 15a, 15b projecting in the direction of the switching disk 7 or respectively in that of the release element 14a or 14b.

In a first segment of movement on insertion of the actuator 5 the projection 15a rests against the flank 16 formed by the release element 14a and, as a result of the insertion movement, rotates the release element 14a relative to the switching disk 7 not yet displaced in the first segment of movement. Only in a second subsequent segment of movement does the central part of the crossbar 15 come to rest against the flank 17 of the switching disk 7 and are moved together clockwise during further insertion of the actuator switching disk 7 and release element 14a.

The opening 18 provided in the actuator 5 is provided for passage of the switching disk 7 or the release element 14a when the actuator 5 is fully inserted into the safety switch 1. Both the switching disk 7 and the release element 14a are designed so that the safety switch 1 may be actuated with the same effect by way of both the first insertion slot 4 and the second insertion slot 6 and in the process is the switching disk 7 is moved in corresponding clockwise direction. As an alternative or in addition it would be possible to provide the second insertion slot 6 near the edge of the housing cover 3 facing the first insertion slot 4 and accordingly to rotate the curved disk 7 in both directions of rotation as a function of the insertion slot 4, 6 selected.

The release element 14a has an opening 20 for passage of the latching element 12a. The opening 20 extends more or less in the form of an arc around the axis of rotation 8 at an angle of approximately 45°. In the exemplary embodiment illustrated the opening 20 is moved back from the radial end of the more or less diskshaped release element 14a and has a closed edge 21. As an alternative to this configuration the edge of the opening 20 may be at least partly open, and in particular may be open radially outward. A closed edge may be advantageous, for example, in the case of a plastic embodiment of the release element 14a, as against an open edge in the case of a metal embodiment. In addition, the edge segment of the opening 20 acting in conjunction with the latching element 12a may also be formed by the outline of the release element 14a, so that the opening is in the form of a radially incident groove suitably formed in the circumferential direction and extending in the radial direction.

The opening 20 has two associated areas openings of different sizes. A first area 22 of the opening 20 is of a width sufficient for engagement of the latching element 12a in the recess 13a in the housing blocking the switching disk 7. The subsequent second area 23 of the opening 20 is in contrast small enough to retain the latching element 12a in its unblocking position. The essential point in the exemplary embodiment illustrated is that the edge sections acting in conjunction with the latching element 12a of the two areas 22, 23 are spaced at different distances from the axis of rotation 8.

The latching element 12a and/or the release element 14a, the latter in particular in the area of the opening 20, have a diagonal area by means of which the rotary movement of the releasing element 14a may be reoriented to axial movement of the latching element 12a. In the exemplary embodiment illustrated the latching element 12a has a tapering segment 24 which operates in conjunction with the more or less cylindrical opening 20 in the release element 14a.

FIG. 3 shows the safety switch 1 of FIG. 2 with the release element 14a removed. As a result, the second energy accumulator, in the form of a torsion spring 25 mounted around the axis 8, is visible. A first leg, not shown in FIG. 3, of the torsion spring 25 rests against the switching disk 7. A second leg 26 of the torsion spring 25 is bent axially at its end and is engaged in a bore 27 of the release element 14a. The torsion spring 25 applies return force to the release element 14a when the actuator 5 is extracted from the safety switch 1. The latching element 12a has two cylindrical, in particular circularly cylindrical, segments which are connected to each other by way of the tapering segment 24.

FIG. 4, in contrast with FIGS. 1 to 3, presents a perspective view rotated 90° of a section through the safety switch 1, the latching element 12a being shown in its blocking position, in which it is engaged by its cylindrical end segment 12c in the hollow cylindrical recess 13a (in the embodiment shown), which is integral with the housing top part 2. As is to be seen from this drawing a release element 14a, 14b is mounted on the two sides of the switching disk 7. The preferably mirror symmetrical release elements 14a, 14b operate in conjunction in each instance with at least one latching element 12a, 12b. The two latching elements 12a, 12b are identical in form on their ends facing away from each other for engagement in respective associated recess 13a, 13b. On their ends facing each other the latching elements 12a, 12b are each cylindrical, in particular hollow cylindrical, in form and are intermeshed in telescope fashion. A common first energy accumulator 11 is mounted inside the cavity thus formed. This accumulator stores mechanical energy when the two latching elements 12a, 12b approach one another.

The switching rod 28, which has electric contact elements (not shown in FIG. 4) mounted on it at its end remote from the curved disk 7, is guided in the safety switch 1 so as to move axially and to be held against a circumferential surface 29. The axis 8 of the switching disk 7 and the release elements 14a, 14b extends transversely to the longitudinal axis 30 of the switching rod 28 and preferably also transversely to the predetermined directions of insertion of the actuator 5 through the insertion slots 4, 6.

1. A device for switching an electric connection as a function of the state of a device to be monitored, in particular a safety switch (1) for a protective device, with a housing (2, 3) in which a switching disk (7) is mounted so as to be rotatable around a axis (8) and in which an actuator (5) may be inserted to initiate the switching process, and a latching device for blocking the switching disk (7), the latching device having a latching element (12a, 12b) guided in the switching disk (7) and movable against the action of a first energy accumulator (11), such latching element (12a, 12b) being engaged in an associated recess (13a, 13b) in the housing (2,3) in a position blocking the switching disk (7), characterized in that the latching mechanism has a rotatable release element (14a, 14b) mounted next to the switching disk (7), which release element (14a, 14b) is rotatable relative to the switching disk (7) when the actuator (5) is inserted, and in that on rotation of the release element (14a, 14b) the latching element (12a, 12b) may be pushed back into the switching disk (7) parallel to the axis (8) against the action of the first energy accumulator (11) and accordingly may be transferred to an unblocking position.

2. The device as claimed in claim 1, wherein the release element (14a, 14b) has an opening (20) for passage of the latching element (12a, 12b).

3. The device as claimed in claim 2, wherein the opening (20) extends around the axis of rotation (8) and has two areas (22, 23) the edges of which are spaced at different distances from the axis of rotation (8).

4. The device as claimed in claim 2 or 3, wherein the opening (20) is open radially outward.

5. The device as claimed one of claims 2 to 4, wherein the opening (20) has a closed edge (21) and two associated areas (22, 23) of different widths.

6. The device as claimed in claim 5, wherein a first area (22) of the opening (20) is of a width sufficient for engagement of the latching element (12a, 12b) in the recess (13a, 13b) in the housing (2, 3) blocking the switching disk (7).

7. The device as claimed in one of claims 1 to 6, wherein the latching element (12a, 12b) and/or the release element (14a, 14b) have/has a diagonal area by means of which the rotary movement of the release element (14a, 14b) may be reoriented to axial movement of the latching element (12a, 12b).

8. The device as claimed in claim 7, wherein the latching element (12a, 12b) has a tapering segment (24) for operation in conjunction with the release element (14a, 14b).

9. The device as claimed in one of claims 1 to 8, wherein a release element (14a, 14b) is mounted on each side of the switching disk (7), wherein the release elements (14a, 14b) each operates in conjunction with at least one latching element (12a, 12b), and wherein the latching elements assciated with each other (12a, 12b) on each side of the switching disk (7) have a common first energy accumulator (11).

10. The device as claimed in one of claims 1 to 9, wherein a switching rod (28) on which electric contact elements are mounted is guided in the housing (2, 3) so as to be axially movable and is kept in contact with a circumferential surface (29) of the switching disk (7), and wherein the axis (8) of the switching disk (7) is mounted transversely to the longitudinal axis (30) of the switching rod (28).
